(19) United States
(12) Patent Application Publication
(10) Pub. No.: US 2016/0189319 A1
(43) Pub. Date: Jun. 30, 2016

(54) VIRTUAL NET METERING FOR PHOTOVOLTAIC SYSTEMS

(71) Applicant: Vivint Solar, Inc., Lehi, UT (US)

(72) Inventors: Roger L. Jungerman, Petulama, CA (US); Randall King, Santa Rosa, CA (US); Daniel Rapp, Lehi, UT (US); Dwain Kinghorn, Highland, UT (US); Thomas Plagemann, New York, NY (US); Ron Binz, Denver, CO (US); Gregory N. Nielson, Lehi, UT (US)

(21) Appl. No.: 14/981,209

(22) Filed: Dec. 28, 2015

Related U.S. Application Data
(60) Provisional application No. 62/097,739, filed on Dec. 30, 2014.

(51) Int. Cl. G06Q 50/06; H02J 1/00; G06Q 10/06

(52) U.S. Cl. CPC G06Q 50/06; G06Q 10/06315; H02J 1/00

(57) ABSTRACT

The present disclosure is related to community virtual net metering of photovoltaic systems. A method may include identifying at least two photovoltaic (PV) system customers in a single geographical area. The method may also include crediting power overproduction of a first PV system customer of the at least two PV system customers to a second, different PV system customer of the at least two PV system customers.

### CROSS-REFERENCE TO RELATED APPLICATIONS

This application claims the benefit of and priority to U.S. Provisional App. No. 62/097,739, filed Dec. 30, 2014, which is incorporated herein by reference.

### TECHNICAL FIELD

This disclosure relates generally to photovoltaic systems and, more specifically, to net metering systems and methods for photovoltaic systems.

### SUMMARY

In one specific embodiment, a method may include producing power with at least one photovoltaic (PV) system in a geographical area. The method may further include crediting power overproduction of a first PV system of the at least one PV system to a second, different PV system of the at least one PV system. According to another embodiment, a method may include identifying at least two PV system customers in a single geographical area. Moreover, the method may include crediting power overproduction of a first PV system customer of the at least two PV system customers to a second, different PV system customer of the at least two PV system customers.

Another embodiment may include a method comprising providing excess energy produced at at least one first property including a PV system to a power system. The method may also include providing power from the power system to at least one second property. By way of example only, the at least one second property may include at least one property without a PV system, at least one property with a PV system, or any combination thereof.

In another specific embodiment, a system includes a plurality of properties within a geographical area and associated with a PV power production system. The system may also include a first entity that owns one or more PV systems of the PV power production system, wherein the first entity receives payment from the plurality of properties. In addition, the system may include a second entity for crediting power overproduction by a first PV system of the PV power production system to a second PV system of the PV power production system.

According to another embodiment, a system includes at least one first property including a PV system. The system further includes a power system configured to receive excess energy generated via the at least one first property. In addition, the system includes at least one second property configured to receive energy from the power system. According to one embodiment, at least property of the at least one second property does not include a PV system.

Yet other embodiments of the present invention comprise computer-readable media storage storing instructions that when executed by a processor cause the processor to perform instructions in accordance with one or more embodiments described herein.

Other aspects, as well as features and advantages of various aspects, of the present invention will become apparent to those of skill in the art through consideration of the ensuing description, the accompanying drawings and the appended claims.

### BRIEF DESCRIPTION OF THE DRAWINGS

Example embodiments will be described and explained with additional specificity and detail through the use of the accompanying drawings in which:

FIG. 1 illustrates a system including a plurality of properties and a utility entity;

FIG. 2 illustrates a photovoltaic system including a plurality of properties, a third-party owner, and a utility entity;

FIG. 3 depicts virtual net metering system, according to an embodiment of the present disclosure;

FIG. 4 is a table illustrating a cost comparison between various utility metering approaches;

FIG. 5 depicts another virtual net metering system, in accordance with an embodiment of the present disclosure.

FIG. 6 illustrates a system including an electronic device, in accordance with various embodiments of the present disclosure;

FIG. 7 is a flowchart depicting a method, in accordance with an embodiment of the present invention;

FIG. 8 is a flowchart depicting another method, according to an embodiment of the present disclosure; and

FIG. 9 is a flowchart depicting yet another method, in accordance with an embodiment of the present disclosure.

### DETAILED DESCRIPTION

Referring in general to the accompanying drawings, various embodiments are illustrated to show the structure and methods for virtual net metering systems. Common elements of the illustrated embodiments are designated with like numerals. It should be understood that the figures presented are not meant to be illustrative of actual views of any particular portion of the actual structure or systems, but are merely schematic representations which are employed to more clearly and fully depict embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Solar panels, which may include a set of solar PV modules, use light energy (photons) from the sun to generate electricity through a photovoltaic effect. A PV system including a plurality of solar panels and various other electrical components may be used to generate and supply electricity in commercial and residential applications. As will be appreciated by a person having ordinary skill in the art, power production from solar PV systems may be net metered (also known as “net metering”) on a site-by-site basis.

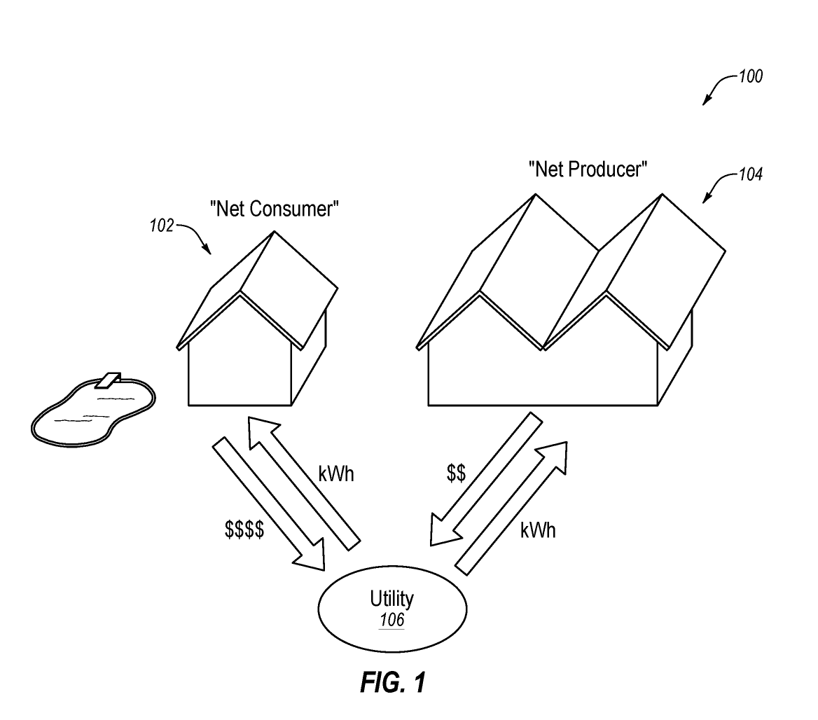

FIG. 1 illustrates a system 100 including a plurality of properties (e.g., residential properties). System 100 includes a property 102 (also referred to herein as “net consumer 102”) that may exhibit relatively high electrical usage but relatively small capacity for solar power production (e.g., due to limited roof space or impediments). System 100 further includes a property 104 (also referred to herein as “net producer 104”) that may exhibit a relatively large capacity for solar power production and relatively low electrical usage. Neither property 102 nor property 104 includes a PV system and, as a result, system 100 is without any net metering capabilities. Each property pays an entity (e.g., a utility company) 106 for its energy usage.

As will be understood by a person having ordinary skill in the art, solar power production from distributed generation (e.g., residential distributed generation) is typically valued at the full marginal retail price of electricity produced. However, solar power production in excess of a customer's annual usage is usually credited at a much lower rate, if at all. This pricing structure may create an incentive to offset the full usage and no more, or in the case of tiered rate structures, the higher marginal rate power alone. When considering the actual costs of installing a PV system, there are significant fixed balance of system (BOS) costs that do not depend significantly upon the size of the PV system. These include such items as permitting, transportation to the site, home electrical system upgrades, and grid interconnection costs. Hence, the actual cost per watt of installing a PV system is reduced when installing larger systems. Stated another way, the marginal cost of adding one additional PV module at a property (e.g., on a roof of a residential property) is much less that the cost of adding the first PV module. In addition, in a typical neighborhood, some properties may have superior conditions for PV system, such as the absence of shading from trees, better roof orientation and roof size. Other properties may not be ideally configured for PV systems due to, for example, poor roof condition or orientation, excessive shade, lack of ownership (i.e., a potential customer is a renter rather than an owner of the property), lack of capital recourses, or financing restrictions such as poor credit ratings. However, the properties with optimal configurations (e.g., the best roof attributes) for a PV system may not be the same properties that require the most electricity.

PV systems are often owned by a third-party owner (“TPO”), which owns and installs PV systems on customer premises, typically at little or no upfront cost to a customer. The TPO makes a return on its upfront investment through long-term contracted monthly payments from the customer. Effectively the customer pays two bills: 1) one bill to the TPO (e.g., at cents per kilowatt-hour rate that is typically lower than a local electrical utility bill); and 2) a second bill to the electrical utility entity at the original rate. The total cost for electricity is typically much lower after installation of the PV system.

In some geographical areas, where the cost of conventional power generation is currently high (e.g., Hawaii), there may be issues with over-production of PV systems on distribution feeders, with PV power production occasionally exceeding the total electrical load. This may cause reversed electrical flow on a distribution feeder, leading to network instabilities or degradation. Hence, a utility company may limit PV installations on distribution feeders. A property owner on a restricted distribution feeder, having a relatively high electrical usage, may wish to contract with a TPO, both to reduce costs and to use a more “green” renewable energy source, but may be prevented from doing so. Other nearby properties, with the same electrical utility, may be on other distribution feeders without as many PV systems. These properties may have sufficient roof space to generate solar electricity in excess of need. In such cases, there can be a mismatch between properties where PV systems can be technically and cost-effectively sited and properties where customers have the electrical usage needs and financial ability to install it.

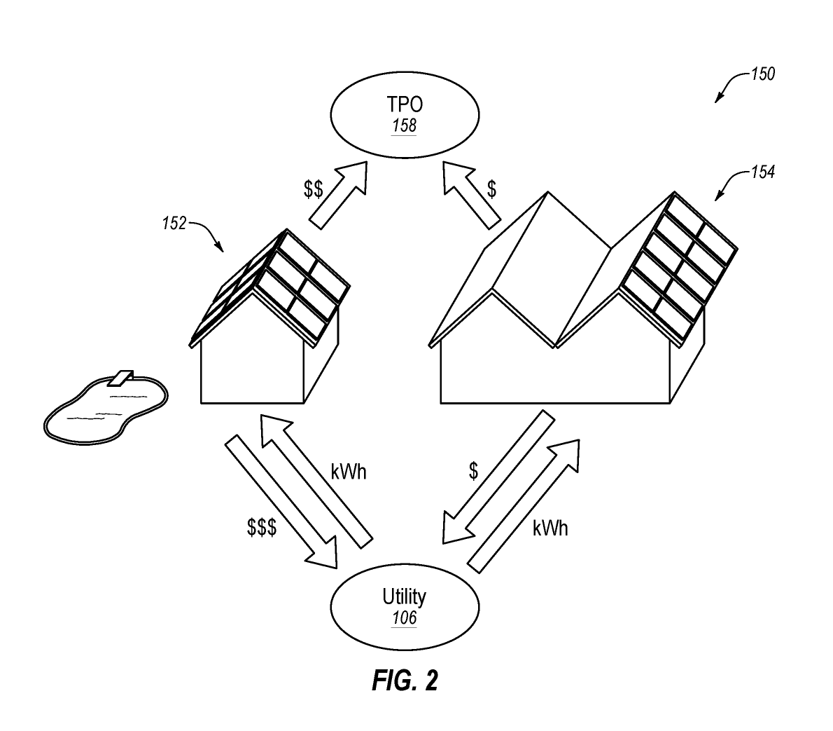

FIG. 2 illustrates a PV system 150 including a plurality of properties (e.g., residential properties). System 150 includes a property 152 having one or more solar panels. Property 152, which also may be referred to herein as “net consumer,” may exhibit relatively high electrical usage but relatively small capacity for solar power production (e.g., due to limited roof space or impediments). System 150 further includes a property 154 having one or more solar panels. Property 154, which may also be referred to herein as “net producer,” may exhibit a relatively large capacity for solar power production and relatively low electrical usage. PV system 150 further includes an owner entity 158, which may also be referred to herein as a TPO. Owner entity 158 may own the solar panels at each of property 152 and property 154. As will be understood, a property including one or more PV panels may pay entity 158 for power generated via the one or more PV panels. Further, each property may pay an entity (e.g., an electrical utility company) 156 for the energy used from entity 156.

Some PV systems include a relatively large solar garden, typically ground-mounted, of PV panels installed at a central location. Property occupants can lease or purchase production of a share of these PV panels. However, many neighborhoods do not have space for a large solar garden, at a reasonable cost. In addition, for aesthetic reasons it is desirable to locate panels on empty rooftops, rather than to take up bare land to be used for the creation of the “solar garden.” In addition, the financing of such aggregated community systems is often difficult for various reasons including the lack of a single credit-worthy entity. Further, electrical utility companies may be resistant to solar gardens, since the power produced at the solar garden may be valued at the full retail rate of the customer. However, the actual electrical load at the property is located some distance away from the solar garden. The utility distribution infrastructure such as power lines used to deliver the power from the “solar garden” to the residence is not entirely compensated for by the net metered utility rate.

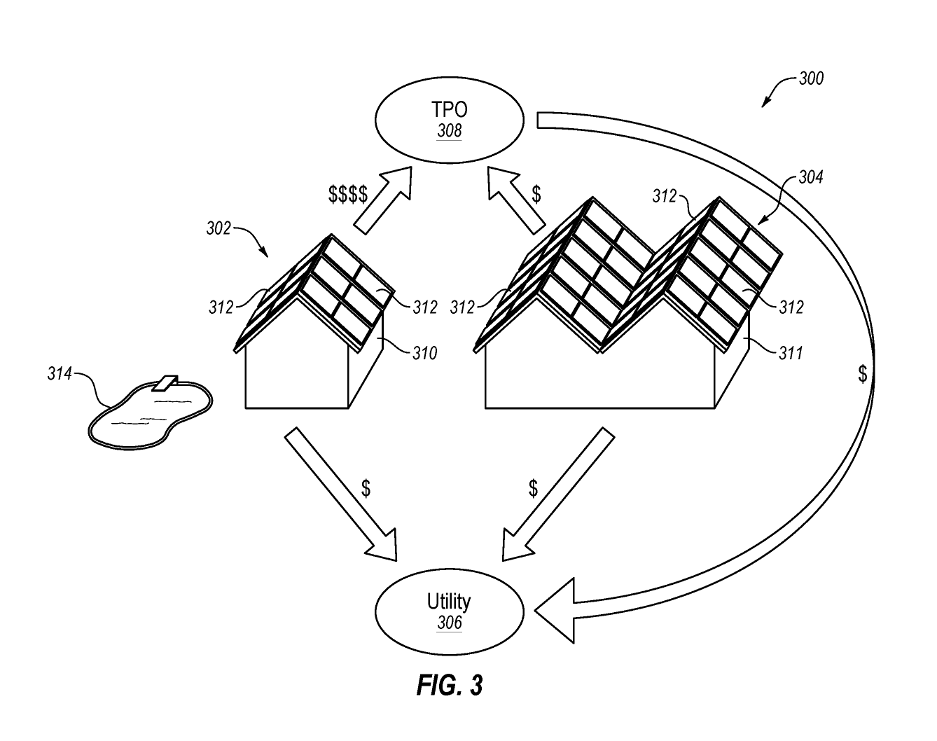

FIG. 3 illustrates a system 300 including a property 302 and a property 304, in accordance with an embodiment of the present disclosure. It is noted although system 300 is illustrated as having two properties, the present disclosure is not so limited. Rather, system 300 may include two or more properties. System 300 may further including an entity 308, which may comprise a TPO. As will be appreciated, a TPO may own PV system equipment (e.g., solar panels and associated equipment). In addition, system 300 may include an entity 306, which may comprise an electrical utility entity (i.e., a utility company). Although not required, both first property 302 and property 304 may have some PV panels installed on their roofs.

According to one example, property 302, which may comprise a PV system, may include a structure (e.g., a house) 310, which consumes electricity. Structure 310 may include one or more solar panels 312 associated therewith (e.g., attached to a roof of structure 310). Further, property 302 may include additional features that require electricity, such as a swimming pool 314. For this example, property 302 has a relatively small roof space and relatively high electricity consumption. Accordingly, property 302 may use more energy than it generates and, therefore, property 302 may also be referred to herein as a “net consumer.” Moreover, continuing with this example, property 304, which may also comprise a PV system, may include a structure (e.g., a house) 311, which consumes electricity. Structure 311 may include one or more solar panels 312 associated therewith (e.g., attached to a roof of structure 311). Property 304 has a relatively large roof space, favorable roof orientation and little shading, but relatively low electricity consumption. Accordingly, property 304 may generate more energy than it uses and, therefore, property 304 may also be referred to herein as a “net producer.”

According to one embodiment of the present disclosure, entity 308 may identify two or more different customers (e.g., property 302 and 304). As will be understood by a person having ordinary skill in the art, it may be relatively straight-forward for entity 308 to identify “net consumer” and “net producer” properties (e.g., as part of neighborhood marketing campaigns including referrals by neighbors).

Further, entity 308 may contact entity 306, which arranges that any power overproduction by property 304 that exceeds the electrical usage by property 304 for a time period (e.g. a month) is not credited to property 304 at a lower rate, but is instead credited to property 302 at property's 302 retail rate. It is noted that the presence of the solar panels on both property 302 and property 304, and the lower utility rate for the PV production, are important in maintaining a contract between a property and entity 308 over a long time period (e.g., twenty years). This is typically possible, even if a property is sold, as the contract has favorable terms and may be assumed by the subsequent purchaser of the property. This long-term viability of the contract is important to entity 308, which who can then obtain financing for PV systems on good terms from third-party investors.

A bill (e.g., a monthly bill) from entity 308 may be adjusted so that property 302 pays entity 308 not only for the energy produced by the PV panels at property 302, but also for some of the energy produced by the PV panels at property 304. Furthermore, according to one embodiment, entity 308 may provide a fee to entity 306 for use of the infrastructure (e.g., electrical distribution infrastructure) for the excess virtual net metered energy, produced by property 304 and sent to property 302. This fee can consist of either or both of a fixed monthly fee and a capacity charge ($/kWh) for the excess energy produced by property 304. Entity 308 can profitably provide this fee to entity 306 due to the reduced installation costs ($/W) it incurs installing a larger system at property 304.

It is noted that electrical utility entities (e.g., entity 306) may have regulatory requirements requiring a certain fraction of electrical production from renewables (e.g., Renewable Portfolio Standard). Thus, embodiments disclosed herein may be attractive to electrical utility entities compared to conventional systems due to the fee paid by entity 308 to entity 306, enabled by the reduced installation costs per Watt of the larger system size at property 304.

As will be appreciated, a customer residing at property 302 may find the lower total electrical bills and the “green” renewable energy attractive. Further, a customer residing at property 304 may receive similar value to traditional systems, and enables the full transaction by making use of their larger roof, which otherwise is an under-utilized asset.

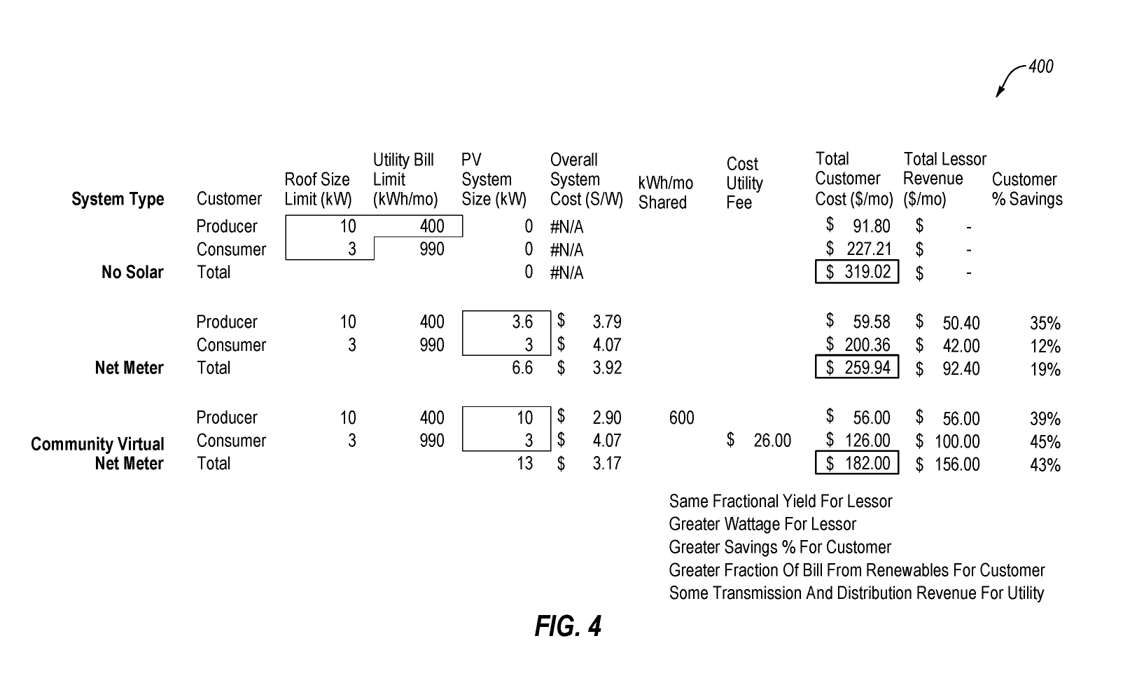

FIG. 4 is a table 400 illustrating a cost comparison between various approaches. In this example, three cases are considered. The “net producer” (e.g., property 304; see FIG. 3) has a large roof and 10 kW PV total capacity, but a fairly small usage (400 kWh/month). By contrast the “net consumer” (e.g., property 302; see FIG. 3) has only 3 kW of capacity of usable roof area while the electrical usage is 990 kWh/month. In a case wherein no solar PV system exists (e.g., system 100 shown in FIG. 1), the total of the two customers' bills is $319/month. Using conventional PV systems (i.e., traditional net metering, see e.g., system 150 of FIG. 2), the total of the customers' bills is $260/month, representing a savings of 19%. The average cost of the two PV systems to a TPO (e.g., entity 158; see FIG. 2) is $3.92/W. Using various embodiments of the present disclosure (“community virtual net metering”; e.g., see system 300 of FIG. 3), the total billing cost to the two customers is $182/month, or a 43% reduction. The total installed cost is a much lower, $3.17/W, due to the larger PV system size. This calculation includes a fee (e.g., a virtual net metering fee) to the utility entity (e.g., entity 306) of $26/month. This is additional revenue that the utility entity (e.g., entity 306) may not have otherwise received, if similar PV generation was achieved using traditional net metering systems. Using embodiments of the present disclosure, the monthly revenue per dollar of installed system cost to the TPO (e.g., entity 308) (($0.045/month)/$ Installed) represents a slight increase in yield (6%) over traditional net metering systems (($0.043/month)/$ Installed).

As will be understood by a person having ordinary skill in the art, PV distribution systems may include too many PV systems and, therefore, lack adequate network stability. According to another embodiment of the present disclosure, some mitigation for a utility company (e.g., entity 306) can be provided as a part of a community virtual net metering contract (i.e., between a TPO (e.g., entity 308) and the electrical utility company (e.g., entity 306)). For example, in addition to, or in lieu of, a virtual net metering utility fee, a TPO could provide advanced distribution grid support. Examples of this electrical distribution grid support include battery storage, and advanced inverter functions including curtailment and grid frequency control, and customer premises load shifting, such as timers and advanced grid controls on loads including air conditioning, dryers, and pumps. Further, the TPO could also fund distribution system infrastructure upgrades to accommodate the high PV production penetration.

In addition, battery storage for time shifting of a PV system output to better match the load in a community virtual net metered system can be provided in a cost-effective manner. Rather than installing individual batteries at each property, more cost-effective large batteries (e.g., shipping container size) can be located at convenient locations on a main “higher-voltage” distribution line. This may reduce the cost of the battery in $/kWh. Further, a TPO can install the battery, if desired by a utility company, and manage the billing of the battery cost to through the multiple community net metering customer payments.

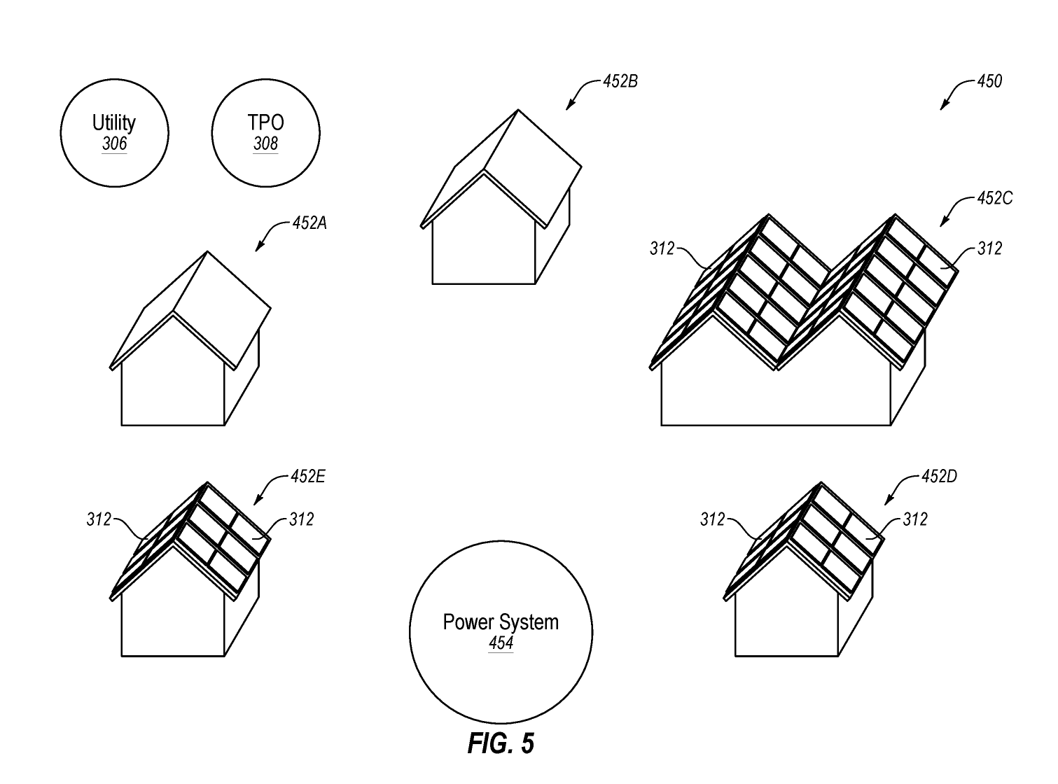

According to another embodiment, energy from one or more overproducing PV systems may be aggregated into a single PV production “pool” from which other properties (i.e., either “net consumer” PV systems or properties without PV systems) may receive energy. FIG. 5 illustrates a system 450 including a plurality of properties 452, in accordance with an embodiment of the present disclosure. System 450 may further including entity 308, which, as noted above, may comprise a TPO. In addition, system 450 may include entity 306, which, as noted above, may comprise an electrical utility entity (i.e., a utility company). It is noted that one or more of properties 452 within system 450 may include an installed PV system, and one or more of properties 452 may not include an installed PV system. System 450 may further include a power system 454, which may comprise a virtual power system. As noted herein, excess energy produced by one or more properties 452 may be aggregated into power system 454.

In accordance with one embodiment, at least one property 452 of system 450 includes an installed PV system and may generate more energy than it uses and, thus, may be considered a “net producer” PV property. Further, at least one other property 452 of system 450 may either be a “net consumer” PV property (i.e., a property that includes an installed PV system and uses more energy than it generates) or a property does not include an installed PV system. In this embodiment, excess energy produced by one or more “net producers” within system 452 may be provided to the grid and aggregated into power system 454, which may provide energy to one or more other properties 452.

In one specific example, properties 452C and 452E may be considered “net producer” PV properties, property 452D is a “net consumer” PV property, and properties 452A and 452B do not include PV systems. In this example, energy produced via PV systems at property 452C, property 452E, or both, may be provided to power system 454. Further, energy from power system 454 may be provided to one or more of properties 452A, 452B, and 452D.

As will be appreciated, system 450 allows for energy to be sold from an aggregate pool (e.g., power system 450), rather than energy being sold directly from one property to another property. Accordingly, system 450 may simplify billing logistics (e.g., between customers, a TPO (e.g., entity 306) and/or a utility entity (e.g., entity 308). It is noted that the same or similar methods regarding crediting, contracting, and/or billing disclosed above with reference to FIG. 3 may be utilized for system 450.

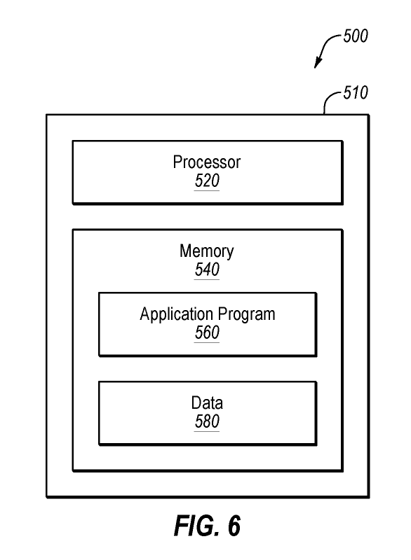

FIG. 6 is a block diagram illustrating an embodiment of a system 500 including an electronic device 510 comprising a processor 520 and memory 540. Processor 520 may comprise any known and suitable processor. Memory 540 may include an application program 560 and data 580, which may comprise stored data. Application program 560 may include instructions that, when read and executed by processor 520, may cause processor 520 to perform the steps necessary to implement and/or use embodiments of the present disclosure. Application program 560 and/or operating instructions may also be tangibly embodied in memory 540, thereby making a computer program product or article of manufacture according to an embodiment the present disclosure. As such, the term “application program” as used herein is intended to encompass a computer program accessible from any computer readable device or media. Further, application program 560 may be configured to access and manipulate data stored in memory 540 of electronic device 510. In addition, memory 540 may be configured for storing any data (i.e., information) related to a PV system and/or a net metering process.

It is noted that system 500 may be used for carrying out embodiments of the present disclosure. For example only, system 500 may be configured to identifying at least two PV system customers in a single geographical area. Further, system 500 may be configured to credit power overproduction of a first PV system customer of the at least two PV system customers to a second, different PV system customer of the at least two PV system customers.

As another example, system 500 may be configured to provide excess energy produced at at least one first property including a PV system to a power system (e.g., a virtual power system). In addition, system 500 may be configured to provide power from the power system to at least one second property, which may or may include an installed PV system.

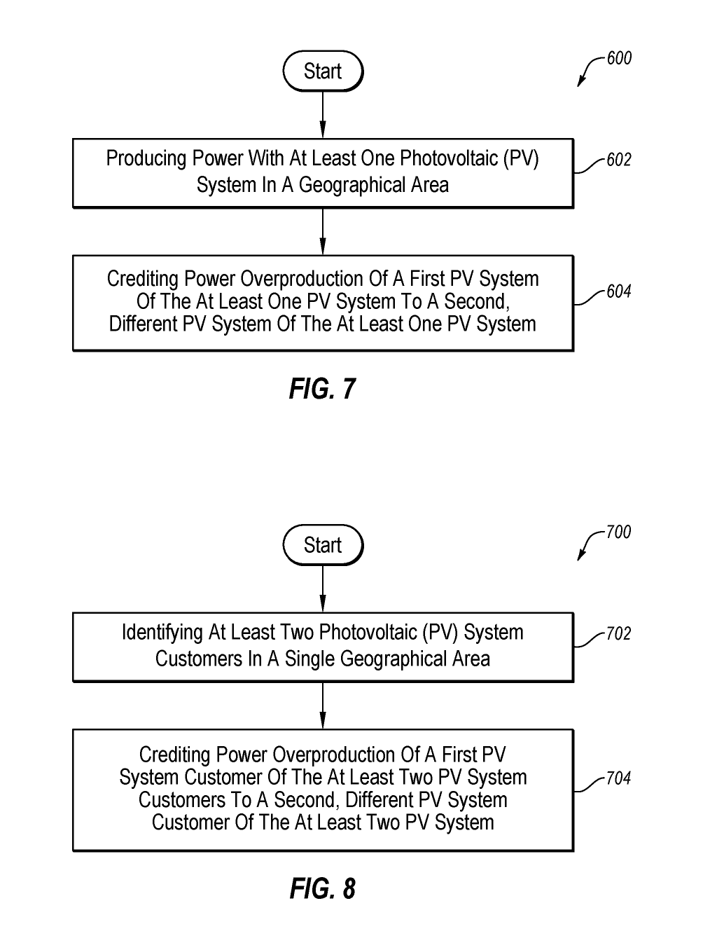

FIG. 7 is a flowchart of a method 600, according to an embodiment of the present disclosure. Method 600 includes producing power with at least one PV system in a geographical area (act 602). Method 600 further includes crediting power overproduction of a first PV system of the at least one PV system to a second, different PV system of the at least one PV system (act 604).

FIG. 8 is a flowchart of a method 700, according to another embodiment of the present disclosure. Method 700 includes identifying at least two PV system customers in a single geographical area (act 702). Method 700 further includes crediting power overproduction of a first PV system customer of the at least two PV system customers to a second, different PV system customer of the at least two PV system customers (act 704).

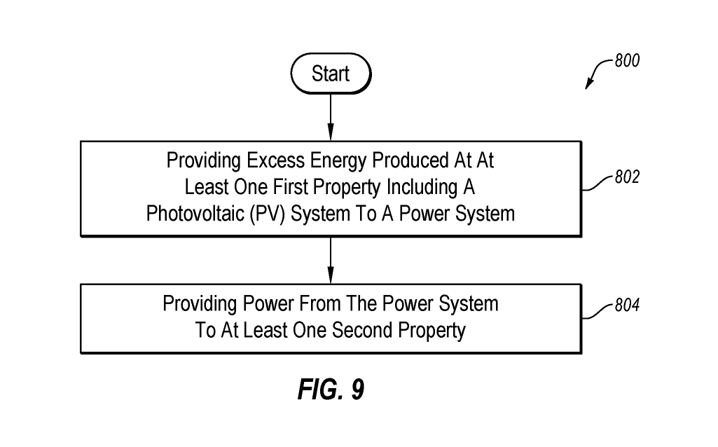

FIG. 9 is a flowchart of yet another method 800, in accordance with an embodiment of the present disclosure. Method 800 includes providing excess energy produced at at least one first property including a PV system to a power system (act 802). Moreover, method 800 includes providing power from the power system to at least one second property (act 804).

Although the foregoing description contains many specifics, these should not be construed as limiting the scope of the disclosure or of any of the appended claims, but merely as providing information pertinent to some specific embodiments that may fall within the scopes of the disclosure and the appended claims. Features from different embodiments may be employed in combination. In addition, other embodiments of the disclosure may also be devised which lie within the scopes of the disclosure and the appended claims. The scope of the disclosure is, therefore, indicated and limited only by the appended claims and their legal equivalents. All additions, deletions and modifications to the disclosure, as disclosed herein, that fall within the meaning and scopes of the claims are to be embraced by the claims.

What is claimed:

1. A method, comprising:
producing power with at least one photovoltaic (PV) system in a geographical area; and
crediting power overproduction of a first PV system of the at least one PV system to a second, different PV system of the at least one PV system.

2. The method of claim 1, further comprising identifying the first PV system and the second, different PV system in the geographical area.

3. The method of claim 2, wherein identifying comprises identifying at least one PV system as a net producer and at least one PV system as a net consumer.

4. The method of claim 3, wherein crediting power overproduction of a first PV system of the at least one PV system to a second, different PV system comprises crediting power overproduction of at least one identified net producer to at least one identified net consumer.

5. The method of claim 1, further comprising managing billing processes for each of the first PV system and the second, different PV system.

6. The method of claim 1, wherein crediting comprises crediting power overproduction by the first PV system that exceeds an electrical usage by the first PV system for a time period to second, different PV system at a retail rate of the second, different PV system.

7. The method of claim 1, further comprising storing energy generated by the at least one PV system with battery positioned on a main distribution line of the first PV system and the second, different PV system.

8. A method, comprising:
identifying at least two photovoltaic (PV) system customers in a single geographical area; and
crediting power overproduction of a first PV system customer of the at least two PV system customers to a second, different PV system customer of the at least two PV system customers.

9. The method of claim 8, further comprising managing billing processes for each of the first PV system customer and the second PV system customer.

10. The method of claim 9, wherein managing comprises adjusting a billing process for the second, different PV system customer so that the second, different PV system customer is billed for energy produced by a PV system at a property of the second, different PV system customer and at least some of the energy produced by a PV system at a property of the first PV system customer.

11. The method of claim 9, wherein managing comprises managing the billing processes with a third party that owns PV systems at a property of the first PV system customer and at a property of the second, different PV system customer.

12. The method of claim 8, further comprising providing payment in the form of fees or ancillary grid support services from an owner entity to a utility entity in exchange for allowing PV power production sharing between the at least two PV system customers.

13. The method of claim 8, wherein crediting comprises crediting power overproduction by the first PV system customer that exceeds an electrical usage by the first PV system customer for a time period to second, different PV system customer at a retail rate of the second, different PV system customer.

14. The method of claim 8, further comprising providing billing information of at least one of the first PV system customer and the second, different PV system customer from a third party owner (TPO) to a utility entity.

15. A system, comprising:
a plurality of properties within a geographical area and associated with a photovoltaic (PV) power production system;
a first entity that owns one or more PV systems of the PV power production system, wherein the first entity receives payment from the plurality of properties; and
a second entity for crediting power overproduction by a first PV system of the PV power production system to a second PV system of the PV power production system.

16. The system of claim 15, the first entity comprising an owner entity and the second entity comprising a utility entity.

17. The system of claim 15, where the first entity provides payment to the second entity for at least one of virtual distribution infrastructure and billing system changes in exchange for allowing power overproduction to be shared between the first and second PV systems.

18. The system of claim 15, the first entity comprising a third-party owner (TPO) of PV equipment associated with each of the first PV system and the second PV system, and the second entity comprising a utility entity.

19. The system of claim 15, wherein the second entity is configured for crediting power overproduction by the first PV system that exceeds an electrical usage by the first PV system for a time period to the second PV system at a retail rate of the second PV system.

20. The system of claim 15, wherein a resident of a property associated with the second PV system pays the first entity for energy produced by the second PV system and at least some of the energy produced by the first PV system.

21. The system of claim 15, further comprising at least one relatively large battery for storing energy from at least two properties of the plurality of properties and positioned on a main distribution line.

22. A system, comprising:
at least one first property including a photovoltaic (PV) system;
a power system configured to receive excess energy generated via the at least one first property; and
at least one second property configured to receive energy from the power system.

23. The system of claim 22, wherein at least one property of the at least one second property does not include an installed PV system.

24. A method, comprising:
providing excess energy produced at at least one first property including a photovoltaic (PV) system to a power system; and
providing power from the power system to at least one second property.

25. The method of claim 24, further comprising aggregating excess energy produced via a plurality of properties of the at least one first property.

26. The method of claim 24, wherein providing power from the power system to at least one second property comprises providing power from the power system to at least one property not including an installed PV system.
